(19) United States
(12) Patent Application Publication
(10) Pub. No.: US 2005/0128376 A1
(43) Pub. Date: Jun. 16, 2005

(54) Liquid crystal display and the backlight module thereof

(76) Inventors: Jeff Chih-Hua Li, Taipei City (TW); Tzu-Pang Chiang, Taoyuan City (TW)

Correspondence Address: RABIN & Berdo, PC, 1101 14TH STREET, NW, SUITE 500, WASHINGTON, DC, 20005, US

(21) Appl. No.: 11/000,037

(22) Filed: Dec. 1, 2004

(30) Foreign Application Priority Data
Dec. 15, 2003 (TW) 92135467

(51) Int. Cl. G02F 1/1335

(52) U.S. Cl. 349/61; 349/68

(57) ABSTRACT

An LCD and the backlight module thereof is provided. The backlight module includes a printed circuit board, a first light source, a first signal-modulating device, and a second light source. The first signal-modulating device is disposed on the printed circuit board and is electrically connected to the first light source. The first light source is adjusted through the first signal-modulating device to generate light with substantially the same luminance as that of the second light source with different luminance characteristics, so that the backlight module achieves uniform luminance.

This application claims the benefit of Taiwan application Serial No. 92135467, filed Dec. 15, 2003, the subject matter of which is incorporated herein by reference.

### BACKGROUND OF THE INVENTION

1. Field of the Invention

The invention relates in general to a liquid crystal display (LCD) and the backlight module thereof, and more particularly to an LCD and the backlight module thereof which can regulate the luminance of at least one of a number of light sources.

2. Description of the Related Art

The conventional LCD uses a backlight module to provide the LCD panel with necessary light. The light source of the backlight module must have the characteristics of high luminance and long lifespan. The backlight module includes mainly a light source, a light guide panel, a diffuser, and a plastic frame. The light source is fixed onto the plastic frame. After the light emitted by the light source is processed by the light guide panel and the diffuser, uniform luminance light is generated to be emitted to the LCD panel. Currently, the most commonly adopted light sources include cold cathode fluorescent lamp (CCFL), hot cathode fluorescent lamp and light emitter diode (LED).

The backlight module can be classified as the edge-type backlight module and the back-type backlight module according to the disposition of the light source on the backlight module. As for the edge-type backlight module, the light source is disposed on lateral sides of the LCD panel, and the light emitted by the light source is transmitted to the central part of the light guide panel disposed at the rear of the LCD panel and is scattered through the light guide panel. As for the back-type backlight module, a number of light sources are disposed at the rear of the LCD panel in parallel to provide the LCD panel with necessary light when displaying.

After a long period of service, one of a number of light sources of the edge-type backlight module disposed on lateral sides of the LCD panel might be broken and cease to emit luminance. Meanwhile, if the broken light source is removed and replaced with a new light source, unbalanced luminance of the two lateral sides will occur and uniformity of LCD panel luminance will deteriorate because the luminance of the new light source is brighter than of the old light source. So, the edge-type backlight module might have unbalanced luminance and deteriorated level of uniformity of luminance.

The same problem might occur to a back-type backlight module, which uses a number of light sources. If one of the light sources of the back-type backlight module is broken and is replaced with a new light source, since the luminance of the new light source is brighter than that of an old light source, the back-type backlight module might still have the same problem of unbalanced and uneven luminance. If an I-shaped light tube is used as the light source, the uneven luminance of the light tube will cause the distribution of alternated bright bars and dark bars to occur on the LCD panel, greatly deteriorating display quality.

### SUMMARY OF THE INVENTION

It is therefore an object of the invention to provide an LCD and the backlight module thereof, which regulates the luminance of one of the light source of the backlight module according to the invention through a signal-modulating device, so that the plural light sources with different luminance characteristics can generate substantially identical luminance enabling the LCD panel to achieve a high level of luminance uniformity.

According to the object of the invention, a backlight module, include a first light source, a printed circuit board, a first inverter, and a first signal-modulating device is provided. The first light source is disposed on the printed circuit board. The inverter is disposed on the printed circuit board for driving the first light source. By modulating the first signal-modulating device, which is disposed on printed circuit board and is electrically connected to the inverter, the luminance of the first light source can be adjusted.

According to another object of the invention, an LCD including a display housing, a signal-socket and a backlight module is provided. The display housing has a receiving space. The signal-socket, which is disposed at the receiving space, provides a first driving signal. The backlight module is removeably disposed at the receiving space. The backlight module includes a printed circuit board, a first light source and a first signal-modulating device. The printed circuit board is selectively electrically connected to the signal-socket for receiving the first driving signal. The first light source is disposed on the printed circuit board. The first driving signal is for driving the first light source. The first signal-modulating device, which is disposed on printed circuit board, is electrically connected to first light source. By modulating the first driving signal through the first signal-modulating device, the luminance of the first light source can be changed.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a three-dimensional diagram of a backlight module according to the first embodiment of the invention;

FIG. 2 is a three-dimensional decomposition diagram of an LCD with the application of the backlight module according to the first embodiment of the invention;

FIG. 3 is a side view of an LCD with the application of the backlight module according to the first embodiment of the invention;

FIG. 4 is a three-dimensional diagram of a backlight module according to the second embodiment of the invention;

FIG. 5 is a side view of a backlight module according to the third embodiment of the invention;

FIG. 6 is a side view of a backlight module according to the fourth embodiment of the invention;

FIG. 7 is a side view of an LCD with the application of the backlight module according to the fourth embodiment of the invention; and

FIG. 8 is a diagram of an edge-type backlight module according to the fifth embodiment of the invention.

### DETAILED DESCRIPTION OF THE INVENTION

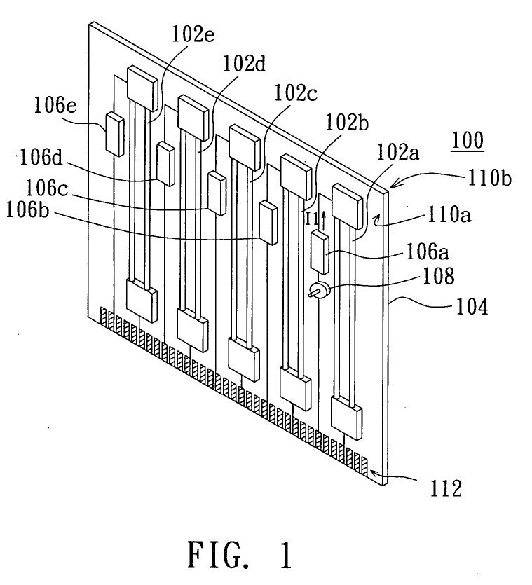

Referring to FIG. 1, a three-dimensional diagram of a backlight module according to a first embodiment of the invention is illustrated. The backlight module 100 includes light sources 102a˜102e, a printed circuit board 104, inverters 106a˜106e, and a signal-modulating device. The light sources 102a˜102e are disposed on the printed circuit board 104. The inverter 106 is disposed on the printed circuit board 104 for driving the light source 102a. The signal-modulating device 108 is disposed on the printed circuit board 104 and is electrically connected to inverter 106a. The luminance of the light source 102a can be adjusted through modulating the signal-modulating device.

Preferably, the signal-modulating device 108 is an adjustable resistor. The inverter 106a is serially connected to the adjustable resistor 108. The inverter 106a outputs a current I1 to drive the light source 102a, and the strength of the current I1 is related to the resistance of the adjustable resistor 108. The light sources 102a˜102e are disposed on an upper surface 110a of the printed circuit board 104, and so are the inverter 106a˜106e and adjustable resistor 108 disposed on the upper surface 110a.

Besides, the lower part of the printed circuit board 104 has a connector 112. The connector 112 can be a number of electrode pads formed at the lower part of the printed circuit board 104 with one of the plural electrode pads being electrically connected to the inverter 106a.

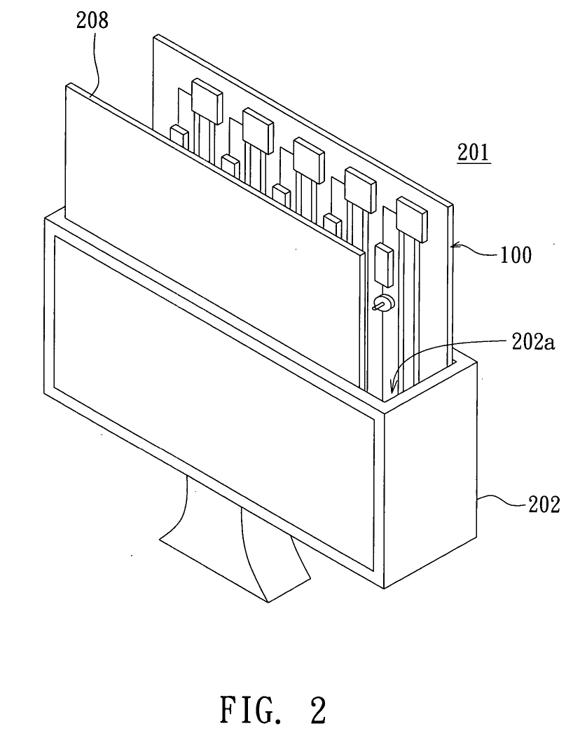

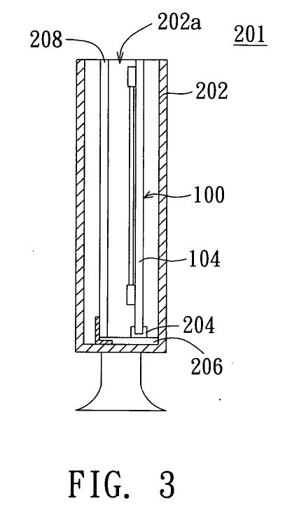

Referring to FIG. 2 and FIG. 3, a three-dimensional decomposition diagram and a side view of an LCD with the application of the backlight module according to the first embodiment of the invention are shown respectively. The LCD 201 includes a display housing 202, a signal-socket 204, a control printed circuit board 206, an LCD panel 208, and a backlight module 100. The display housing 202 has a receiving space 202a. The signal-socket 204, which is disposed in the receiving space 202a, is positioned at the bottom of the display housing 202. The control printed circuit board 206 is electrically connected to the LCD panel 208 for driving the LCD panel 208 to display the image. The signal-socket 204 is disposed on the control printed circuit board 206 and is electrically connected to the control printed circuit board 206. The backlight module 100 is removeably disposed in the receiving space 202a. When the backlight module 100 moves downward to the bottom, the backlight module 100 is inserted onto the signal-socket 204, enabling the connector 112 disposed on the bottom of the printed circuit board 104 to be electrically connected to the signal-socket 204. By doing so, the printed circuit board 104 can be electrically connected to the control printed circuit board 206 for receiving the power transmitted from the control printed circuit board 206.

Refer to FIG. 1 and FIG. 2 at the same time. When the light source 102a is the new light source to replace the broken light source while the light sources 102b˜102e are old light sources, the luminance of the new light source, i.e., the light source 102a, will be brighter than that of the light sources 102b˜102e having been in service over a period of time. By adjusting the resistance of the adjustable resistor 108, the strength of the current I1 outputted by the inverter 106a will be changed. For example, if the resistance of the adjustable resistor 108 is increased, the current I1 will be reduced. When the light source 102a is driven by a reduced current I1, the luminance of the light source 102a will be reduced to be close to that of the light sources 102b˜102e. Therefore, the LCD 201 can achieve a high level of luminance uniformity.

On the other hand, if the light source 102e is the new light source to replace the broken light source originally disposed at the first left position of the diagram while the light sources 102a˜102d are old light sources, the light source 102a, which is an old light source, will be moved to the first left position of the diagram while the light source 102e, which is a new light source, will be moved to the first right position of the diagram. The above steps can be repeated. Through adjusting the adjustable resistor 108, the luminance of the new light source can be reduced to be close to that of the old light sources. After the broken light source of the old light source is replaced with a new light source, the LCD 201 still achieves a high level of luminance uniformity.

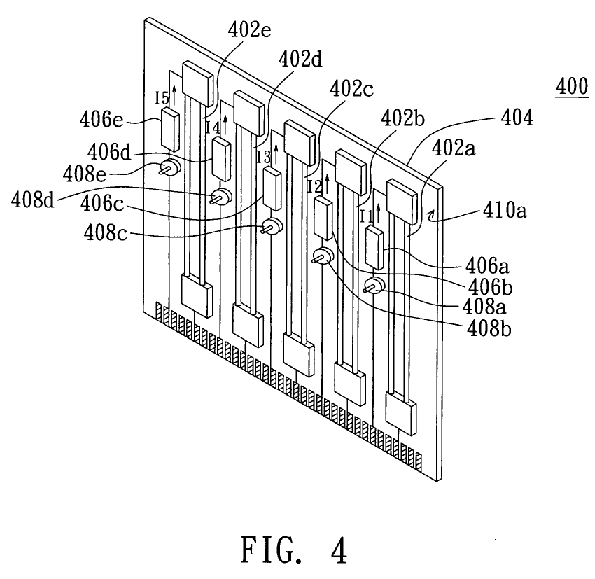

Referring to FIG. 4, a three-dimensional diagram of a backlight module 400 according to a second embodiment of the invention is shown. The second embodiment differs with the first embodiment in that at least two light sources of the light sources 402a˜402e are electrically connected to the signal-modulating device. FIG. 4 is an example when respective light source of the light sources 402a˜402e is electrically connected to a signal-modulating device. The signal-modulating device can be an adjustable resistor for instance. The inverters 406a˜406e and the adjustable resistors 408a˜408e are disposed on the upper surface 410a of the printed circuit board 404, but are positioned between two adjacent light sources or besides the corresponding light source. The inverters 406a˜406e, which are serially connected with the adjustable resistors 408a˜408e respectively, output currents I1˜I5 respectively for driving the light sources 402a˜402e, wherein the strength of the currents I1˜I5 are related to the resistance of the adjustable resistors 408a˜408e. Through modulating the resistance of the adjustable resistors 408a˜408e, the luminance of the light sources 402a˜402e can be adjusted to be substantially identical.

In the second embodiment, the light sources 402a˜402e have different luminance characteristics. For example, the light sources might have different periods of service or their original luminance might be different as well. The backlight module 400 can be connected to a signal socket which simulates the signal-socket 204 of a factory or service center, then regulate the resistance of the adjustable resistors 408a˜408e until the luminance of light sources 402a˜402e are identical before inserting the backlight module 400 into the receiving space 202a to be connected with the signal-socket 204, so that the LCD 201 can assure a high level of luminance uniformity.

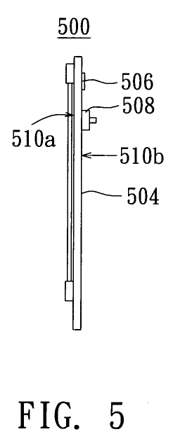

Referring to FIG. 5, a side view of a backlight module according to a third embodiment of the invention is shown. The third embodiment differs with the first embodiment and the second embodiment in that, the inverter 506 and adjustable resistor 508 of a backlight module 500 according to the third embodiment are disposed on the lower surface 510b of the printed circuit board 504, wherein the lower surface 510b is opposite to the upper surface 510a. Such practice can save the size of the printed circuit board 504 effectively, or allow the light sources to be arranged and disposed on the upper surface 510amore closely to improve luminance.

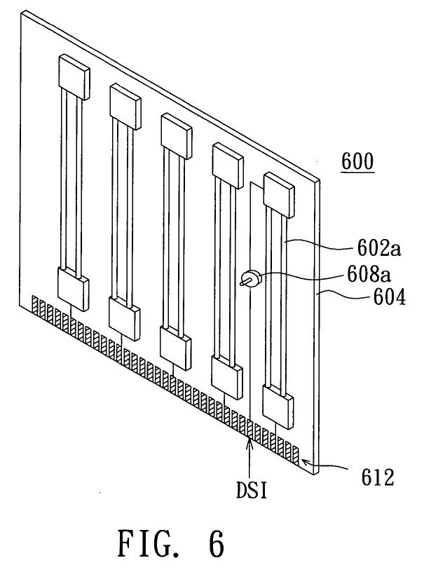

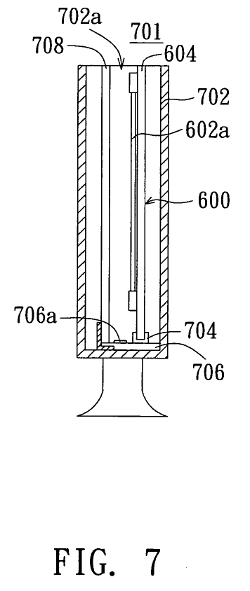

Refer to FIG. 6 and FIG. 7 at the same time, wherein FIG. 6 is a side view of a backlight module 600 according to the fourth embodiment of the invention, while FIG. 7 is a side view of an LCD 701 with the application of the backlight module according to the fourth embodiment of the invention. The LCD 701 includes a display housing 702, a signal-socket 704, a control printed circuit board 706, an LCD panel 708, and a backlight module 600. The display housing 702 has a receiving space 702a. The signal-socket 704 is disposed in the receiving space 702a for receiving a first driving signal DSI. The backlight module 600 is removeably disposed at the receiving space 702a.

The backlight module 600 includes a printed circuit board 604, light sources 602a˜602e and a signal-modulating device. The signal-modulating device can be an adjustable resistor 608a for instance. The printed circuit board 604 can be selectively electrically connected to signal-socket 704 for receiving the first driving signal DSI. The light source 602a˜602e are disposed on the printed circuit board 604. The first driving signal DSI is for driving the light source 602a. The adjustable resistor 608a, which is disposed on the printed circuit board 604, is electrically connected to the light source 602a. The luminance of the light source 602a can be adjusted through modulating the first driving signal DSI by the adjustable resistor 608a.

The adjustable resistor 608a can regulate the power of the first driving signal DSI inputted to the light source 602a, so the strength of the current of the first driving signal DSI is related to the resistance of the adjustable resistor 608a. Through modulating the resistance of the adjustable resistor 608a, the current of the drive light source 602a can be adjusted, so that the light source 602a and the light sources 602b˜602e, whose luminance characteristics were originally different, can generate substantially identical luminance.

The control printed circuit board 706 is for controlling the LCD panel 708. The control printed circuit board 706 has an inverter 706a, which is used for generating driving signal DSI. When the backlight module 600 is inserted into the signal-socket 704, the connector 612 positioned at one side of the printed circuit board 604a is electrically connected to the signal-socket 704, so that the driving signal DSI generated by the inverter 706a can be transmitted to the light source 602a through the adjustable resistor 608a.

In the fourth embodiment, at least two light sources can be electrically connected to the adjustable resistor correspondingly to regulate the luminance of the light sources. Under this circumstance, the driving current for driving the light sources can also be provided by the control printed circuit board. The adjustable resistor of backlight module according to the fourth embodiment, like the backlight module 400a according to the second embodiment, can be disposed between two adjacent light sources or besides a corresponding light source. Besides, the adjustable resistor of backlight module according to the fourth embodiment, like the backlight module 500a according to the third embodiment, can be disposed on the lower surface of the printed circuit board 604. The light sources 602a˜602e can be achieved by CCFL or hot cathode fluorescent lamp.

Moreover, if the light sources 602a˜602e adopt a light emitter diode (LED), the control printed circuit board 706 can be dispensed with the inverter 706a which is needed if a CCFL is adopted.

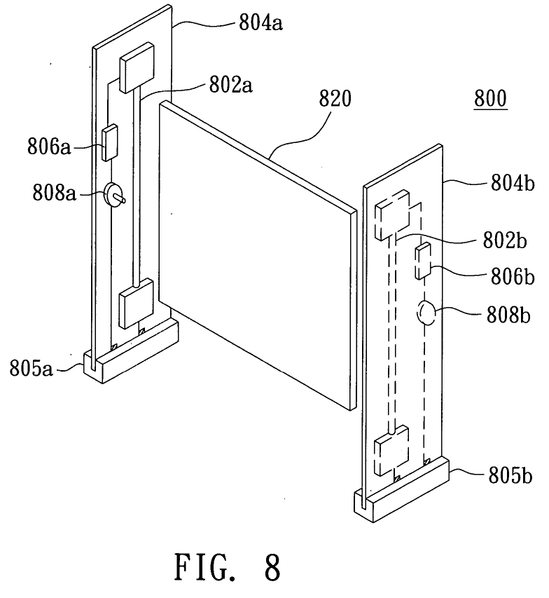

The backlight modules according to the first embodiment to the fourth embodiment of the invention are back-type backlight modules. Nonetheless, the spirit of the invention can be applied to the edge-type backlight module. Referring to FIG. 8, a diagram of an edge-type backlight module according to the fifth embodiment of the invention is shown. A light source 802a, an inverter 806a and an adjustable resistor 808a are disposed on the printed circuit board 804a. A light source 802b, an inverter 806b and an adjustable resistor 808b are disposed on the printed circuit board 804b. The adjustable resistor 808a and 808b are respectively electrically connected to the inverters 806a and 806b. An edge-type backlight module 800 has a light guide panel 820. The light sources 802a and 802b are respectively disposed at the two sides of the light guide panel 820. When the light source 802a and 802b are having different luminance characteristics, by modulating the luminance of the light sources 802a and 802b through modulating the adjustable resistors 808a and 808b, the luminance of the light source 802a and that of the light source 802b will be the same, so that the luminance of the light guide panel 820 will have a high level of uniformity.

The printed circuit boards 804a and 804b are not necessary to have the inverters 806a and 806b disposed thereon. When the printed circuit boards 804a and 804b are electrically connected the signal-sockets 805a and 805b respectively, the printed circuit boards 804a and 804b will receive respective driving signal for driving the light sources 802a and 802b respectively.

The backlight module of the invention can adopt a light source such as a CCFL, a hot cathode fluorescent lamp, an LED, or other light source whose luminance is adjustable. Any light source whose luminance can be changed through modulating the power of a driving signal adjusted through a signal-modulating device can be applied to the backlight module of the invention.

The LCD and the backlight module thereof disclosed in the above preferred embodiments of the invention, through a signal-modulating device, enable the light sources whose luminance characteristics are different to generate substantially identical luminance, so that the LCD panel can achieve a high level of luminance uniformity.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A backlight module, comprising:
a first printed circuit board;
a first light source, being disposed on the first printed circuit board;
a first inverter, being disposed the first printed circuit board for driving the first light source; and
a first signal-modulating device, being disposed on the first printed circuit board, and electrically connected to the first inverter, the luminance of the first light source being adjusted by modulating the first signal-modulating device.

2. The backlight module according to claim 1, wherein the first signal-modulating device is a first adjustable resistor.

3. The backlight module according to claim 2, wherein the first inverter is serially connected with the first adjustable resistor, the first inverter outputs a first current for driving the first light source, the strength of the first current is related to the resistance of the first adjustable resistor.

4. The backlight module according to claim 1, wherein the first light source is disposed on a first surface of the first printed circuit board, while the first inverter and the first signal-modulating device are also disposed on the first surface.

5. The backlight module according to claim 1, wherein the first light source is disposed on a first surface of the first printed circuit board while the first inverter and the first signal-modulating device are disposed on the second surface, wherein the first surface is opposite to the second surface.

6. The backlight module according to claim 1, wherein one side of the first printed circuit board has a connector, the connector is electrically connected to the first inverter, the first printed circuit board is electrically connected to an external circuit through the connector.

7. The backlight module according to claim 1, wherein the backlight module further comprise a second light source, a second inverter and a second signal-modulating device, the second light source is disposed on the first printed circuit board, the second inverter is disposed on the first printed circuit board for driving the second light source, the second signal-modulating device is disposed on the first printed circuit board and is electrically connected to the second inverter, through modulating the resistance of the second signal-modulating device, the luminance of the second light source can be adjusted so that the luminance of the first light source and the luminance of the second light source are substantially identical.

8. The backlight module according to claim 7, wherein the second signal-modulating device is a second adjustable resistor.

9. The backlight module according to claim 8, wherein the second inverter, which is serially connected to the second adjustable resistor, outputs a second current, whose strength is related to the resistance of the second adjustable resistor, for driving the second light source, at least one of the first inverter and the second inverter is disposed between the first light source and the second light source, through modulating the resistance of the first adjustable resistor and the luminance of the second adjustable resistor, the first light source and the second light source, whose luminance characteristics are different, generate substantially identical luminance.

10. The backlight module according to claim 9, wherein the first light source and the second light source is a cold cathode fluorescent lamp (CCFL) or a hot cathode fluorescent lamp.

11. The backlight module according to claim 1, wherein the backlight module further comprise a second light source, a second printed circuit board, a second inverter, a second signal-modulating device and a light guide panel, the second light source is disposed on the second printed circuit board, the second inverter is disposed on the second printed circuit board for driving the second light source, while the second signal-modulating device is disposed on the second printed circuit board and is electrically connected to the second inverter, the first light source and the second light source are disposed at the two sides of the light guide panel, through modulating the resistance of the second signal-modulating device, the luminance of the second light source can be adjusted so that the luminance of the first light source and the luminance of the second light source are substantially identical.

12. A liquid crystal display (LCD), comprising:
a display housing, having an receiving space;
a first signal-socket, being disposed within the receiving space for providing a first driving signal; and
a backlight module, being removeably disposed within the receiving space, comprising:
a first printed circuit board, being selectively electrically connected to the first signal-socket for receiving the first driving signal;
a first light source, being disposed on the first printed circuit board and driven by the first driving signal; and
a first signal-modulating device, being disposed on the first printed circuit board and electrically coupled to the first light source, through modulating the first driving signal passing through the first signal-modulating device, the luminance of the first light source being adjusted.

13. The LCD according to claim 12, wherein the backlight module further comprises a second light source and a second signal-modulating device, the second light source is disposed on the first printed circuit board, while the second signal-modulating device is disposed on the first printed circuit board and is electrically connected to the second light source, the first signal-socket further provides a second driving signal to the first printed circuit board, through modulating the second signal-modulating device, the luminance of the second light source can be changed so that the luminance of the first light source and the luminance of the second light source are substantially identical.

14. The LCD according to claim 13, wherein the first signal-modulating device is a first adjustable resistor, while the second signal-modulating device is a second adjustable resistor.

15. The LCD according to claim 13, wherein the strength of first driving current is related to the resistance of the first adjustable resistor, the strength of the second driving current is related to the resistance of the second adjustable resistor, through modulating the resistance of the first adjustable resistor and that of the second adjustable resistor, the first light source and the second light source, whose luminance characteristics are different, generate substantially identical luminance.

16. The LCD according to claim 13, wherein the first light source and the second light source are disposed on a first surface of the first printed circuit board, while the first adjustable resistor and the second adjustable resistor are also disposed on the first surface, at least one of the first adjustable resistor and the second adjustable resistor is disposed between the first light source and the second light source.

17. The LCD according to claim 13, wherein the first light source and the second light source are disposed on a first surface of the first printed circuit board while the first adjustable resistor and the second adjustable resistor are disposed on a second surface, the first surface is opposite to the second surface.

18. The LCD according to claim 13, wherein the first light source and the second light source are light emitter diode (LEDs).

19. The LCD according to claim 13, wherein the LCD further comprises a first control printed circuit board for controlling the LCD panel, the first control printed circuit board has a first inverter and a second inverter, which respectively generates the first driving signal and the second driving signal.

20. The LCD according to claim 19, wherein the first light source and the second light source is either a CCFL or a hot cathode fluorescent lamp.

21. The LCD according to claim 12, wherein the backlight module further comprises a second light source, a second printed circuit board, a second signal-modulating device, a light guide panel and a second signal-socket, the second light source is disposed the second printed circuit board, while the second signal-modulating device is disposed on the second printed circuit board and is electrically connected to the second light source, the second signal-socket further provides a second driving signal to the second printed circuit board, the first light source and the second light source are disposed at the two sides of the light guide panel, through modulating the second signal-modulating device, the luminance of the second light source can be changed so that the luminance of the first light source and the luminance of the second light source are substantially identical.
